(19) United States
(12) Patent Application Publication
(10) Pub. No.: US 2016/0150327 A1
(43) Pub. Date: May 26, 2016

(54) Photosensitive Microphone

(71) Applicant: Knowles Electronics, LLC, Itasca, IL (US)

(72) Inventors: Sarmad Qutub, Des Plaines, IL (US); Martin Volk, Willowbrook, IL (US); John Albers, Chicago, IL (US)

(21) Appl. No.: 14/945,706

(22) Filed: Nov. 19, 2015

Related U.S. Application Data
(60) Provisional application No. 62/084,369, filed on Nov. 25, 2014.

(51) Int. Cl. H04R 23/00; H04R 1/04

(52) U.S. Cl. CPC H04R 23/008; H04R 1/04; H04R 2201/003; H04R 2499/11

(57) ABSTRACT

A microphone includes a base; a micro electro mechanical system (MEMS) device disposed on the base, the MEMS device configured to convert sound into a first electrical signal; an integrated circuit disposed on the base and coupled to the MEMS device; a photo diode disposed on the base, the photo diode configured to convert light into a second electrical signal. At least one of the first electrical signal and the second electrical signal is processed by the integrated circuit.

### CROSS-REFERENCE TO RELATED APPLICATION

This patent claims benefit under 35 U.S.C. §119(e) to U.S. Provisional Application No. 62/084,369 entitled “Photosensitive microphone” filed Nov. 25, 2014, the content of which is incorporated herein by reference in its entirety.

### TECHNICAL FIELD

This application relates to microphones and, more specifically, to microphones providing photosensitive functionality.

### BACKGROUND OF THE INVENTION

Different types of acoustic devices have been used through the years. One type of device is a microphone. In a microelectromechanical system (MEMS) microphone, a MEMS die includes a diagram and a back plate. The MEMS die is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential of the back plate, which creates an electrical signal. Microphones are deployed in various types of consumer electronic devices such as personal computers or cellular phones.

Photo sensors are also used in many consumer electronic devices as discrete components that are separate from the acoustic elements such as the microphones. However, these photosensitive elements require a large footprint and this is visible to the consumer. In many cases, the sensors appear large and unsightly on the exterior of the device (e.g., on the exterior of the cellular phone). This negative cosmetic appearance is a negative influence on consumers who may not wish to purchase the device because of the unsightly appearance.

These problems of previous approaches have resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1A comprises a side cutaway view of a top port microphone according to various embodiments of the present invention;

FIG. 1B comprises a side cutaway view of a top port microphone according to various embodiments of the present invention;

FIG. 1C comprises a side cutaway view of a MEMS on lid or bottom port microphone according to various embodiments of the present invention;

FIG. 1D comprises a side cutaway view of a MEMS on lid or bottom port microphone according to various embodiments of the present invention;

FIG. 1E comprises a side cutaway view of a MEMS on lid or bottom port microphone according to various embodiments of the present invention;

FIG. 1F comprises a side cutaway view of a MEMS on lid or bottom port microphone according to various embodiments of the present invention;

FIG. 1G comprises a side cutaway view of a MEMS on lid or bottom port microphone according to various embodiments of the present invention;

FIG. 2A comprises a block diagram of a MEMS microphone according to various embodiments of the present invention;

FIG. 2B comprises a block diagram of a MEMS microphone according to various embodiments of the present invention;

FIG. 2C comprises a block diagram of a MEMS microphone according to various embodiments of the present invention;

FIG. 2D comprises a block diagram of a MEMS microphone according to various embodiments of the present invention;

FIG. 3A comprises a block diagram of a MEMS microphone according to various embodiments of the present invention;

FIG. 3B comprises a block diagram of a MEMS microphone according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide photo diodes or other photo sensing devices within MEMS microphone assemblies. The approaches described herein are cost effective to implement and result in a pleasing visual appearance for the consumer device (in which the MEMS microphone is disposed) because the photo diode does not add any additional visual footprint compared to what the consumer device would already need for the microphone alone.

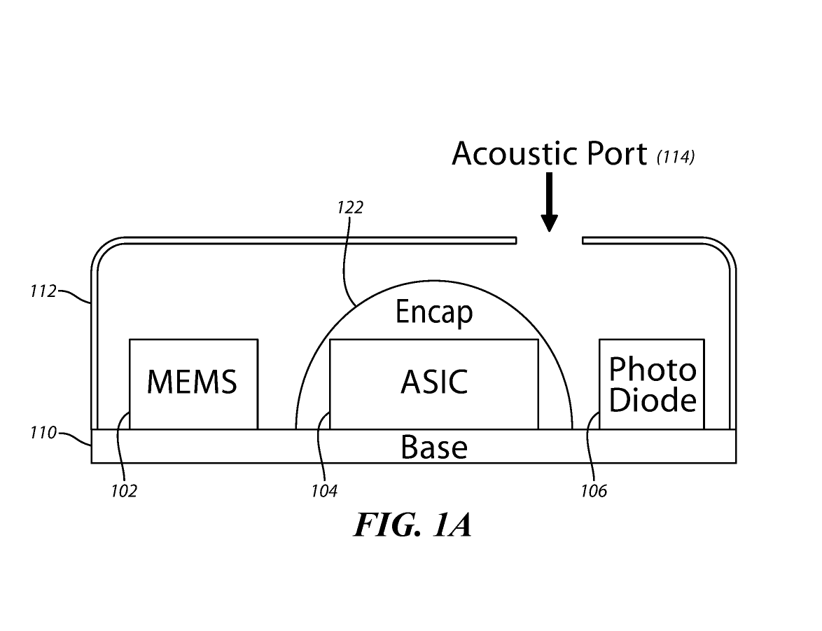

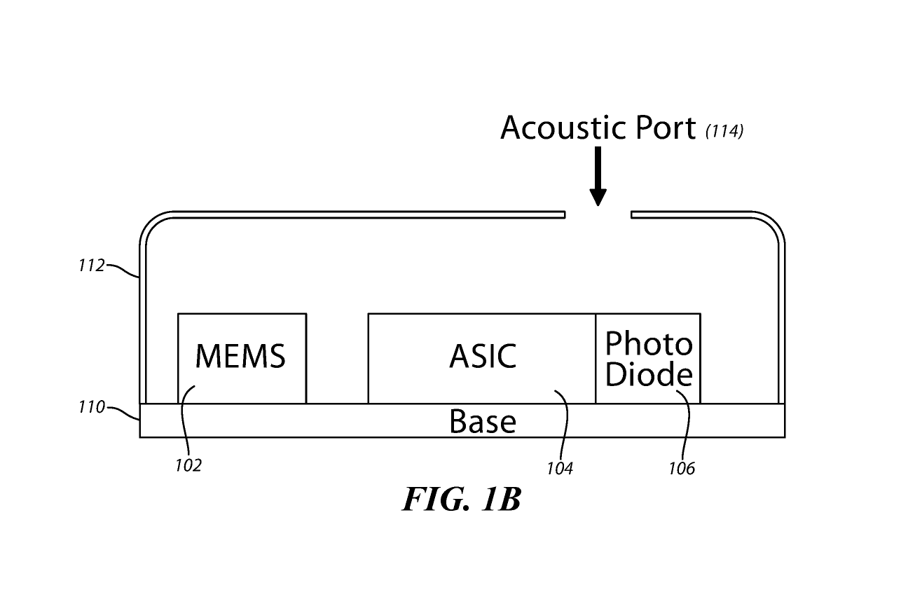

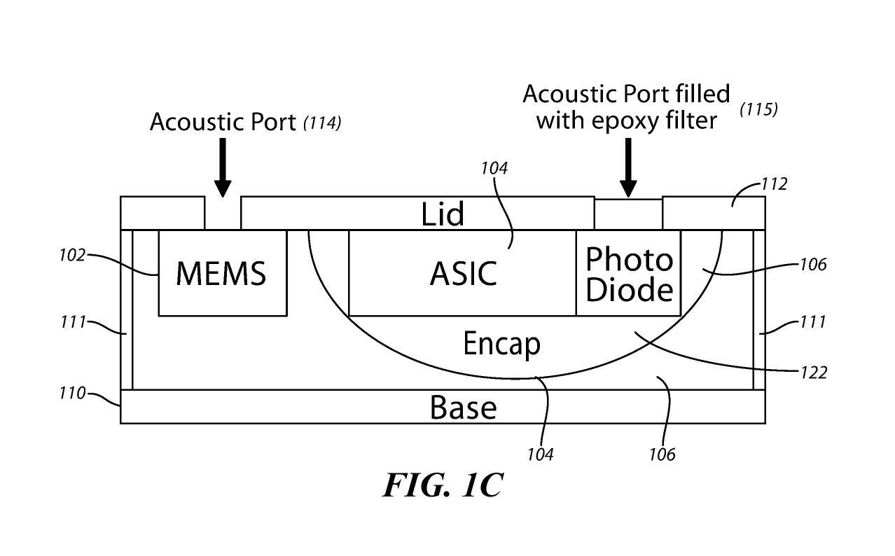

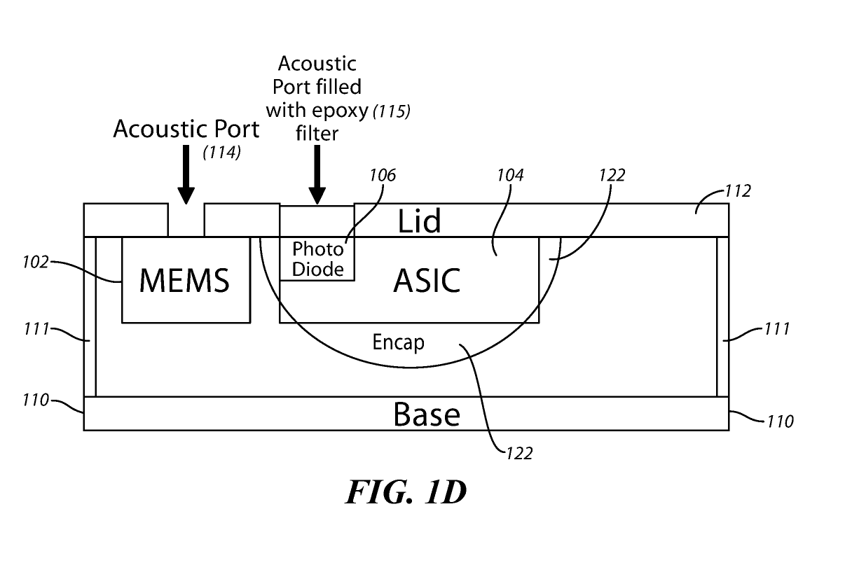

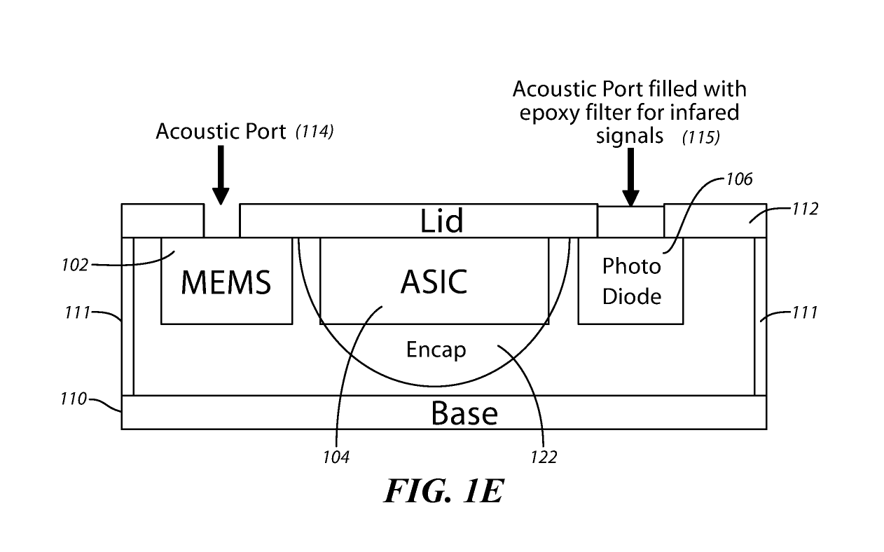

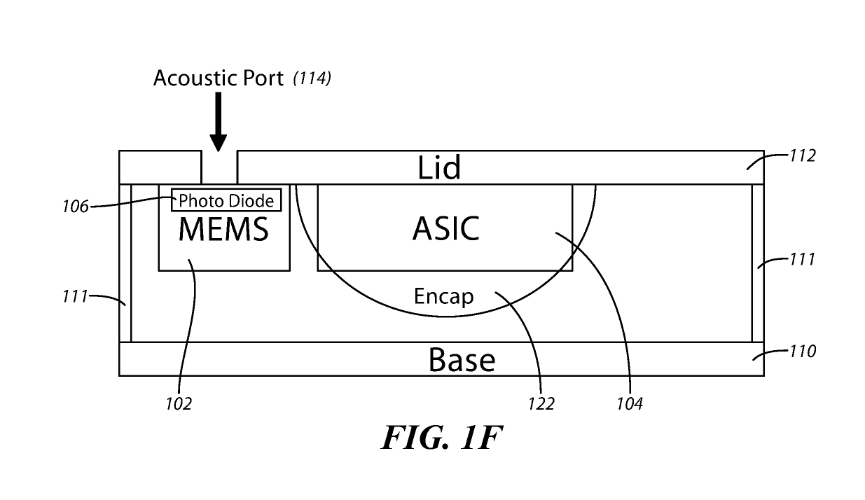

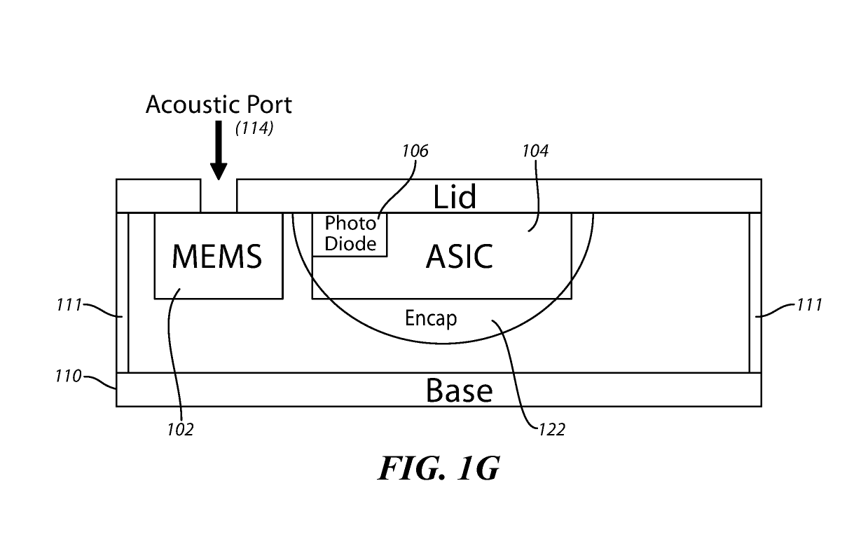

Referring now to FIGS. 1A-1G various examples of microphones/microphone assemblies are described. Each of these figures utilizes similarly numbered elements.

Referring now to FIG. 1A, one example of a microphone 100 is described. The microphone 100 includes a MEMS device 102, an application specific integrated circuit (ASIC) 104, and a photo diode 106. The MEMS device 102 converts sound energy into a first electrical signal and, in one aspect, includes a diaphragm and a back plate. The ASIC 104 receives the first electric signal from the MEMS device 102 and performs further processing (e.g., amplification and/or noise removal to mention two examples) on the first electrical signal. The photo diode 106 receives light energy and converts this light energy into a second electrical signal. The second electrical signal may be further processed by the ASIC 104. As used herein, a photo diode is any photo-sensitive device that receives light energy and converts the light energy into electrical signals.

The microphone 100 in FIG. 1A also includes a cover 112, and the MEMS device 102, the ASIC 104 and the photo diode 106 are disposed on a base 110. The base 110 may be a printed circuit board, in one example. The cover 112 is coupled to the base 110 to enclose the MEMS device 102, the ASIC 104, and the photo diode 106. A port 114 extends through the cover 112 making the microphone 100 of FIG. 1A a top port device. An encapsulation 122 extends about the ASIC 104. The encapsulation 122 may be a silicon polymerin one example, and is used to protect the ASIC 104. Both light and sound energy enter the microphone via the port 114.

Referring now to FIG. 1B, another example of a microphone 100 is described. The microphone 100 includes a MEMS device 102, an application specific integrated circuit (ASIC) 104, and a photo diode 106. The MEMS device 102 converts sound energy into a first electrical signal and, in one aspect, includes a diaphragm and a back plate. The ASIC 104 receives the first electric signal from the MEMS device 102 and performs further processing (e.g., amplification and/or noise removal to mention two examples) on the first electrical signal. The photo diode 106 receives light energy and converts this light energy into a second electrical signal. The second electrical signal may be further processed by the ASIC 104.

The microphone 100 in FIG. 1B also includes a cover 112, and the MEMS device 102, the ASIC 104 and the photo diode 106 are disposed on a base 110. The base 110 may be a printed circuit board, in one example. The cover 112 is coupled to the base 110 to enclose the MEMS device 102, the ASIC 104, and the photo diode 106. A port 114 extends through the cover 112 making the microphone 100 of FIG. 1B a top port device. The photo diode 106 may be coupled to or incorporated into the ASIC 104 in this example. Both light and sound energy enter the microphone via the port 114.

Referring now to FIG. 1C, another example of a microphone 100 is described. The microphone 100 includes a MEMS device 102, an application specific integrated circuit (ASIC) 104, and a photo diode 106. The MEMS device 102 converts sound energy into a first electrical signal and, in one aspect, includes a diaphragm and a back plate. The ASIC 104 receives the first electric signal from the MEMS device 102 and performs further processing (e.g., amplification and/or noise removal to mention two examples) on the first electrical signal. The photo diode 106 receives light energy and converts this light energy into a second electrical signal. The second electrical signal may be further processed by the ASIC 104.

The microphone 100 in FIG. 1C also includes a lid 112, side walls 111, and the MEMS device 102, the ASIC 104 and the photo diode 106 are disposed on the lid 112. A base 110 is coupled to the side walls 111. The base 110 may be a printed circuit board, in one example. The lid 112 encloses the MEMS device 102, the ASIC 104, and the photo diode 106. A first port 114 extends through the lid 112 and communicates with the MEMS device 102. A second port 115 extends through the lid 112 and communicates with the photo diode 106. The second port 115 may be filled with an epoxy (or similar material) in order to filter light wavelengths and/or protect the photodiode from environmental conditions. The photo diode 106 may be coupled to the side of the ASIC 104 in this example. An encapsulation 122 extends about the ASIC 104 and the photo diode 106. The encapsulation 122 may be a silicon polymer in one example, and is used to protect the ASIC 104. The microphone 100 of FIG. 1C may be classified as a MEMS-on-lid device, or as a bottom port device. The port 114 allows sound to enter the microphone while the port 115 allows light to enter the microphone.

Referring now to FIG. 1D, another example of a microphone 100 is described. The microphone 100 includes a MEMS device 102, an application specific integrated circuit (ASIC) 104, and a photo diode 106. The MEMS device 102 converts sound energy into a first electrical signal and, in one aspect, includes a diaphragm and a back plate. The ASIC 104 receives the first electric signal from the MEMS device 102 and performs further processing (e.g., amplification and/or noise removal to mention two examples) on the first electrical signal. The photo diode 106 receives light energy and converts this light energy into a second electrical signal. The second electrical signal may be further processed by the ASIC 104.

The microphone 100 in FIG. 1D also includes a lid 112, side walls 111, and the MEMS device 102, the ASIC 104 and the photo diode 106 are disposed on the lid 112. A base 110 is coupled to the side walls 111. The base 110 may be a printed circuit board, in one example. The lid 112 encloses the MEMS device 102, the ASIC 104, and the photo diode 106. A first port 114 extends through the lid 112 and communicates with the MEMS device 102. A second port 115 extends through the lid 112 and communicates with the photo diode 106. The second port 115 may be filled with an epoxy (or similar material) in order to filter light wavelengths and/or protect the photodiode from environmental conditions. The photo diode 106 incorporated into or be held by the ASIC 104 in this example. An encapsulation 122 extends about the ASIC 104 and the photo diode 106. The encapsulation 122 may be a silicon polymer, in one example, and is used to protect the ASIC 104. The microphone 100 of FIG. 1D may be classified as a MEMS-on-lid device, or as a bottom port device. The port 114 allows sound to enter the microphone while the port 115 allows light to enter the microphone.

Referring now to FIG. 1E, another example of a microphone 100 is described. The microphone 100 includes a MEMS device 102, an application specific integrated circuit (ASIC) 104, and a photo diode 106. The MEMS device 102 converts sound energy into a first electrical signal and, in one aspect, includes a diaphragm and a back plate. The ASIC 104 receives the first electric signal from the MEMS device 102 and performs further processing (e.g., amplification and/or noise removal to mention two examples) on the first electrical signal. The photo diode 106 receives light energy and converts this light energy into a second electrical signal. The second electrical signal may be further processed by the ASIC 104.

The microphone 100 in FIG. 1E includes a lid 112, side walls 111, and the MEMS device 102, the ASIC 104 and the photo diode 106 are disposed on the lid 112. A base 110 is coupled to the side walls 111. The base 110 may be a printed circuit board, in one example. The lid 112 encloses the MEMS device 102, the ASIC 104, and the photo diode 106. A first port 114 extends through the lid 112 and communicates with the MEMS device 102. A second port 115 extends through the lid 112 and communicates with the photo diode 106. The second port 115 may be filled with an epoxy (or similar material) in order to filter light wavelengths and/or protect the photodiode from environmental conditions. The photo diode 106 is separate from the ASIC 104 in this example. An encapsulation 122 extends about the ASIC 104. The encapsulation 122 may be a silicon polymer in one example, and is used to protect the ASIC 104. The microphone 100 of FIG. 1E may be classified as a MEMS-on-lid device, or as a bottom port device. The port 114 allows sound to enter the microphone while the port 115 allows light to enter the microphone.

Referring now to FIG. 1F, another example of a microphone 100 is described. The microphone 100 includes a MEMS device 102, an application specific integrated circuit (ASIC) 104, and a photo diode 106. The MEMS device 102 converts sound energy into a first electrical signal and, in one aspect, includes a diaphragm and a back plate. The ASIC 104 receives the first electric signal from the MEMS device 102 and performs further processing (e.g., amplification and/or noise removal to mention two examples) on the first electrical signal. The photo diode 106 receives light energy and converts this light energy into a second electrical signal. The second electrical signal may be further processed by the ASIC 104.

The microphone 100 in FIG. 1F includes a lid 112, side walls 111, and the MEMS device 102, the ASIC 104 and the photo diode 106 are disposed on the lid 112. A base 110 is coupled to the side walls 111. The base 110 may be a printed circuit board, in one example. The lid 112 encloses the MEMS device 102, the ASIC 104, and the photo diode 106. A port 114 extends through the lid 112 and communicates with the MEMS device 102 and the photo diode 106. The photo diode 106 is incorporated into the MEMS device in this example. An encapsulation 122 extends about the ASIC 104 and the photo diode 106. The encapsulation 122 may be a silicon polymer in one example, and is used to protect the ASIC 104. The microphone 100 of FIG. 1E may be classified as a MEMS-on-lid device, or as a bottom port device. Both light and sound energy enter the microphone via the port 114.

Referring now to FIG. 1G, another example of a microphone 100 is described. The microphone 100 includes a MEMS device 102, an application specific integrated circuit (ASIC) 104, and a photo diode 106. The MEMS device 102 converts sound energy into a first electrical signal and, in one aspect, includes a diaphragm and a back plate. The ASIC 104 receives the first electric signal from the MEMS device 102 and performs further processing (e.g., amplification and/or noise removal to mention two examples) on the first electrical signal. The photo diode 106 receives light energy and converts this light energy into a second electrical signal. The second electrical signal may be further processed by the ASIC 104.

The microphone 100 in FIG. 1G also includes a lid 112, side walls 111, and the MEMS device 102, the ASIC 104 and the photo diode 106 are disposed on the lid 112. A base 110 is coupled to the side walls 111. The base 110 may be a printed circuit board, in one example. The lid 112 encloses the MEMS device 102, the ASIC 104, and the photo diode 106. A port 114 extends through the lid 112 and communicates with the MEMS device 102 and with the photo diode 106. The photo diode 106 incorporated into or be held by the ASIC 104 in this example. An encapsulation 122 extends about the ASIC 104 and the photo diode 106. The encapsulation 122 may be a silicon polymer, in one example, and is used to protect the ASIC 104. The microphone 100 of FIG. 1G may be classified as a MEMS-on-lid device, or as a bottom port device. The port 114 allows sound to enter the microphone while the port 115 allows light to enter the microphone.

In the examples of FIGS. 1C-1G, the walls 111 and lid 112 could be replaced with a single metal can.

In any of the examples of FIGS. 1A-1G, sound energy is received and converted into electrical signals by the MEMS device 102. The photo diode 106 is any photo-sensitive device that receives light energy and converts the light energy into electrical signals. As mentioned above, in some arrangements the light and sound enter through the same port, while in other arrangements light and sound enter through different ports. Light may also enter through semi-translucent or completely translucent embodiments of the MEMS microphone package. The electrical signals received from the MEMS device 102 and the photo diode 106 may be further processed by the ASIC 104. After processing, the processed signals can be sent to a consumer electronics device, for instance, via pads (not shown) on the base 110 that are coupled to the ASIC 104.

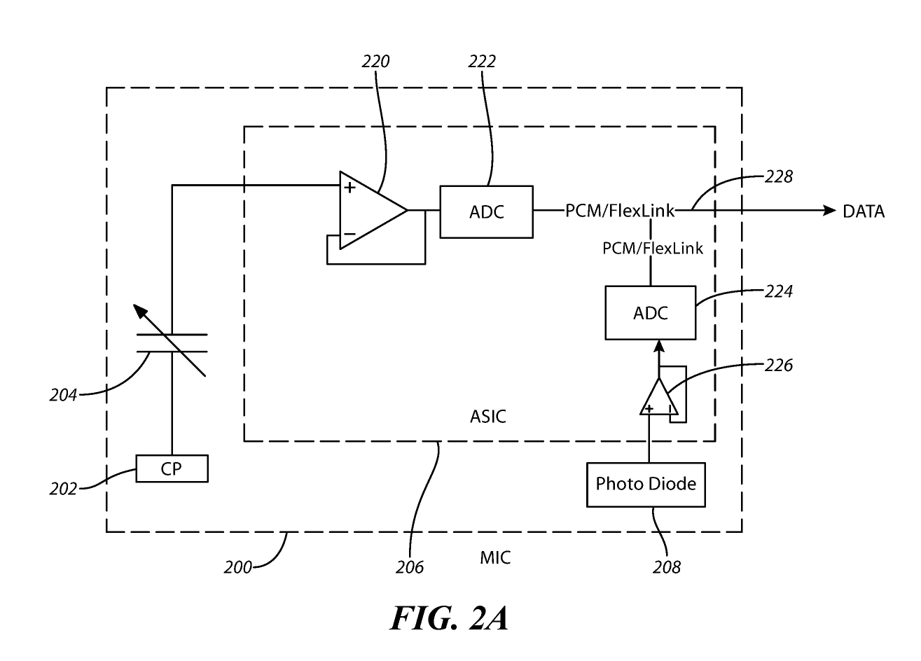

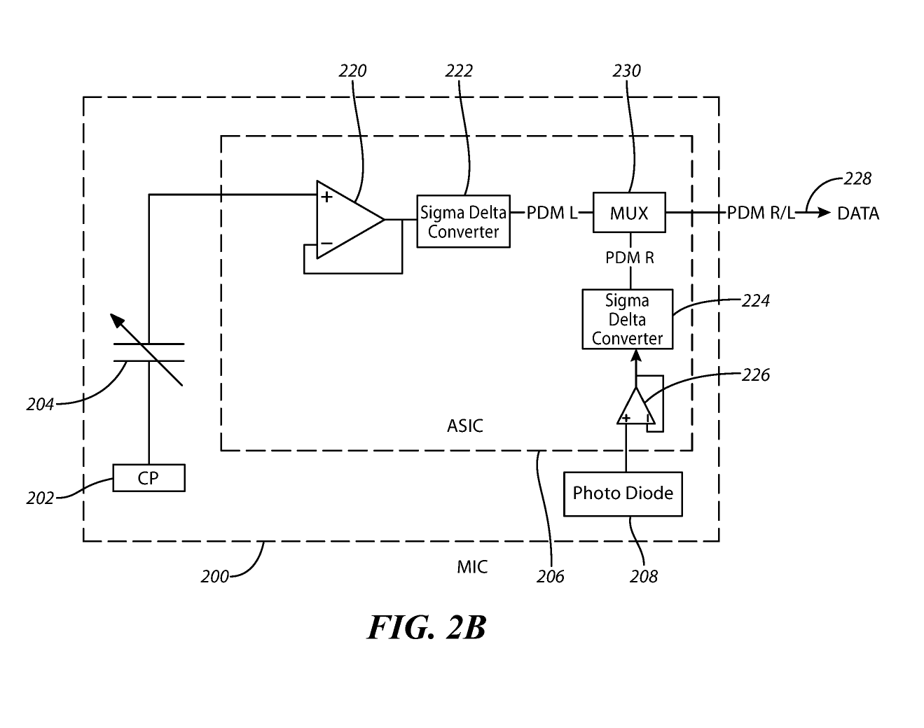

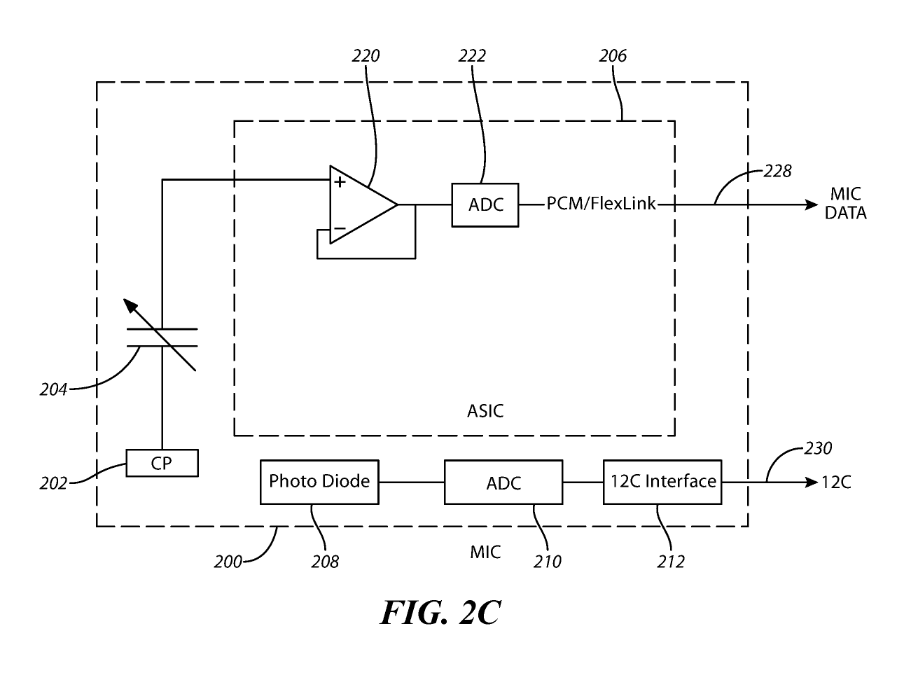

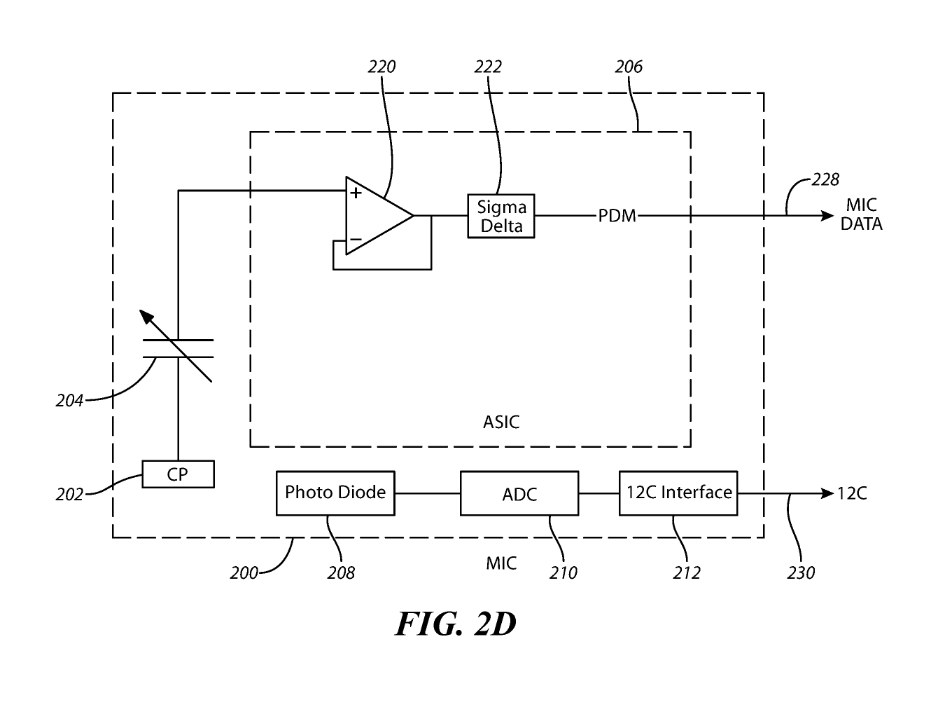

Referring now to FIGS. 2A-2D various examples of microphones are described. Each of these figures utilizes similarly numbered elements.

Referring now to FIG. 2A, another example of a microphone 200 is described. The microphone 200 includes a charge pump 202, a MEMS device 204, an ASIC 206 and a photo diode 208. The ASIC 206 includes a first amplifier 220, a first analog-to-digital converter (ADC) 222, a second ADC 224, and a second amplifier 226. The first ADC 222 and second ADC are coupled to a Flexlink-compliant data bus 228, which transmits the pulse code modulation (PCM) data that it receives.

In operation, the charge pump 202 provides voltage to the MEMS device 204, which receives sound energy and transforms the sound energy to an electrical signal that is received by the ASIC 206. The signal is buffered and amplified by the first amplifier 220 and converted into a digital PCM signal by the first ADC 222 and placed on the bus 228. The photo diode 208 receives light energy, converts this to an electric signal that is received by the second amplifier 226, which buffers and amplifies this analog signal. The analog signal is transformed into a PCM digital signal by the second ADC 224, which places the digital signal on the bus 228.

Referring now to FIG. 2B, another example of a microphone 200 is described. The microphone 200 includes a charge pump 202, a MEMS device 204, an ASIC 206 and a photo diode 208. The ASIC 206 includes a first amplifier 220, a first sigma delta converter 222, a second sigma delta converter 224, and a second amplifier 226. The first sigma delta converter 222 and the second sigma delta converter 224 are coupled to a multiplexer 230, which chooses which input signal to place on output data line 228. The designation of each signal on the left or right channel is predefined by design.

In operation, the charge pump 202 provides voltage to the MEMS device 204, which receives sound energy and transforms the sound energy to an electrical signal that is received by the ASIC 206. The signal is buffered and amplified by the first amplifier 220 and converted into a digital PDM signal by the sigma delta converter 222. The photo diode 208 receives light energy, converts this to an analog electric signal that is received by the second amplifier 226 which buffers and amplifies this analog signal. The analog signal is transformed into a PDM digital signal by the second sigma delta converter 224. The multiplexer 230 chooses which of the input signals to place on output data line 228.

Referring now to FIG. 2C, another example of a microphone 200 is described. The microphone 200 includes a charge pump 202, a MEMS device 204, an ASIC 206, a photo diode 208, a first analog to digital converter 210, and an I2C interface 212 The ASIC 206 includes an amplifier 220, and a second analog-to-digital converter (ADC) 222 that are coupled to a Flexlink-compliant data bus 228.

In operation, the charge pump 202 provides voltage to the MEMS device 204, which receives sound energy and transforms the sound energy to an electrical signal that is received by the ASIC 206. The signal is buffered and amplified by the amplifier 220 and converted into a digital PCM signal by the ADC 222. The ADC 222 places the data on the data bus 228.

The photo diode 208 receives light energy, converts this to an analog electric signal that is received by the first ADC 210, which converts this into a digital signal compatible with the I2C interface 212, which places the signal onto I2C line 230.

Referring now to FIG. 2D, another example of a microphone 200 is described. The microphone 200 includes a charge pump 202, a MEMS device 204, an ASIC 206, a photo diode 208, a first analog to digital converter 210, and an I2C interface 212. The ASIC 206 includes an amplifier 220, a sigma delta converter 222 that is coupled to a data bus 228.

In operation, the charge pump 202 provides voltage to the MEMS device 204, which receives sound energy and transforms the sound energy to an electrical signal that is received by the ASIC 206. The signal is buffered and amplified by the amplifier 220 and converted into a digital PDM signal by the sigma delta converter 222. The sigma delta converter 222 places the data on the data bus 228.

The photo diode 208 receives light energy, converts this to an analog electric signal that is received by the first ADC 210, which converts this into a digital signal compatible with the I2C interface 212, which places the signal onto I2C line 230.

In any of the embodiments described in FIGS. 2A-2D, a single analog to digital converter may be used instead of two discrete converters. The analog output of the light-sensitive element can also be transmitted without being converted to a digital signal in any of these embodiments.

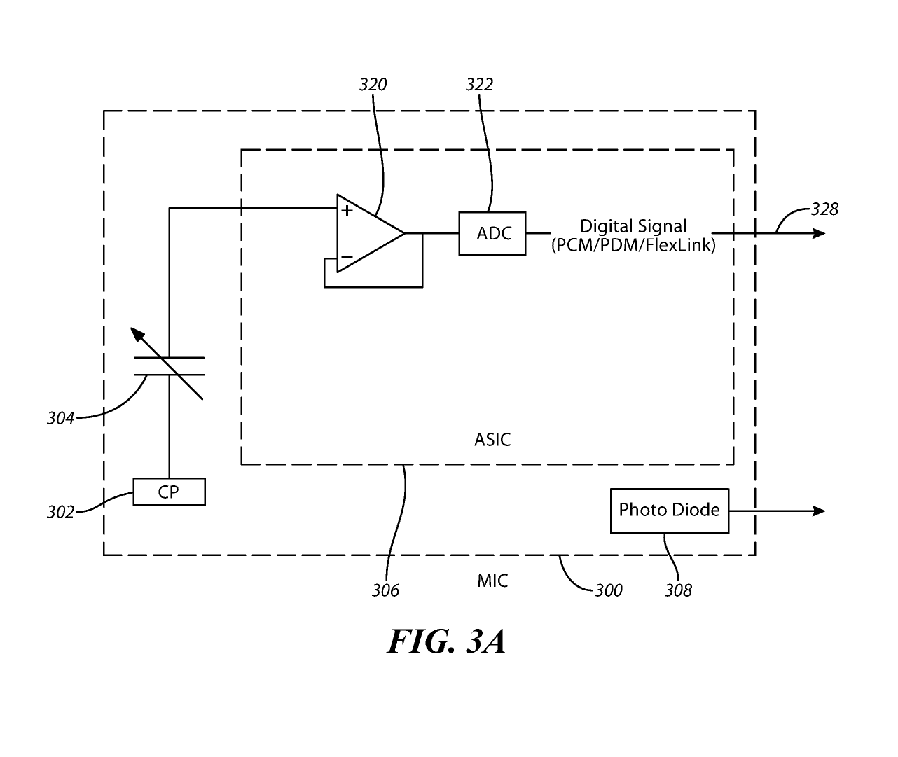

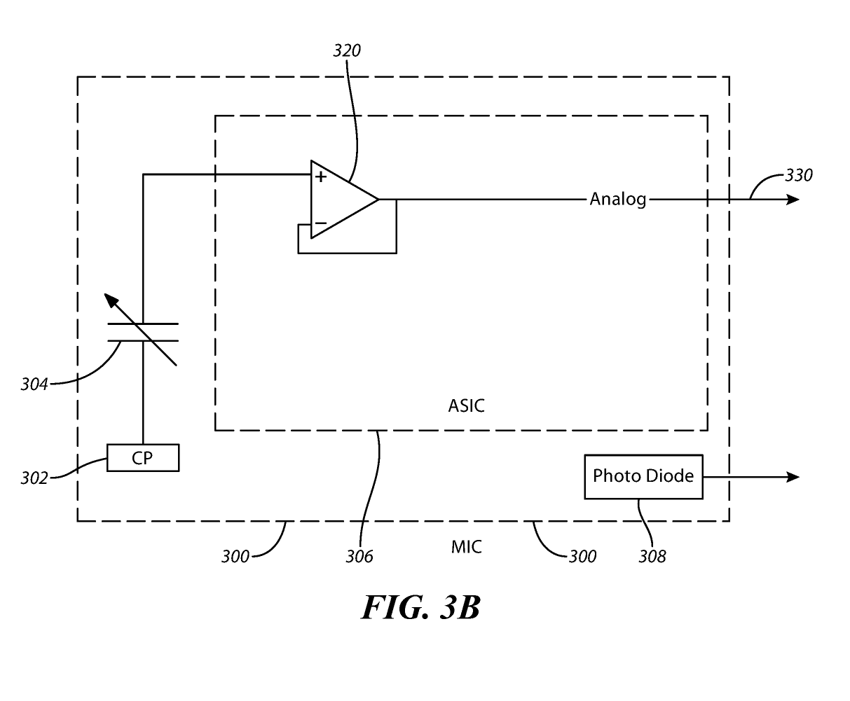

Referring now to FIG. 3A, an example of a microphone 300 is described. The microphone 300 includes a charge pump 302, a MEMS device 304, an ASIC 306, a photo diode 308. The ASIC 306 includes an amplifier 320, an analog-to-digital converter (ADC) 322 that is coupled to a data bus 328.

In operation, the charge pump 302 provides voltage to the MEMS device 304, which receives sound energy and transforms the sound energy to an electrical signal that is received by the ASIC 306. The signal is buffered and amplified by the amplifier 320 and converted into a digital PDM signal by the ADC 322. The ADC 322 places the data on the data bus 328. The photo diode 308 receives light energy, converts this to an analog electric signal that is transmitted outside the microphone 300 (e.g., to an external ADC or processor).

Referring now to FIG. 3B, an example of a microphone 300 is described. The microphone 300 includes a charge pump 302, a MEMS device 304, an ASIC 306, a photo diode 308. The ASIC 306 includes an amplifier 320 that is coupled to an analog output 330.

In operation, the charge pump 302 provides voltage to the MEMS device 304, which receives sound energy and transforms the sound energy to an electrical signal that is received by the ASIC 306. The signal is buffered and amplified by the amplifier 320 and placed the data on the analog output 330. The photo diode 308 receives light energy, converts this to an analog electric signal that is transmitted outside the microphone 300 (e.g., to an external ADC or processor).

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microphone, comprising:
a base;
a micro electro mechanical system (MEMS) device disposed on the base, the MEMS device configured to convert sound into a first electrical signal;
an integrated circuit disposed on the base and coupled to the MEMS device;
a photo diode disposed on the base, the photo diode configured to convert light into a second electrical signal;
a cover disposed on the base and enclosing the MEMS device, the integrated circuit, and the photo diode;
wherein at least one of the first electrical signal and the second electrical signal is processed by the integrated circuit.

2. The microphone of claim 1, wherein the photo diode couples to the integrated circuit.

3. The microphone of claim 1, wherein the photo diode couples to a device to the exterior of the microphone, and not to the integrated circuit.

4. The microphone of claim 1, wherein the integrated circuit is encapsulated by an encapsulator.

5. The microphone of claim 1, wherein the photodiode is physically separate from the integrated circuit.

6. The microphone of claim 1, wherein the photodiode is disposed on the integrated circuit.

7. The microphone of claim 1, wherein sound energy and light enter through the same port through the base.

8. The microphone of claim 1, wherein sound energy and light enter through different pathways through the base.

9. The microphone of claim 1, wherein the microphone is disposed in a smartphone, personal computer, or tablet.

10. The microphone of claim 1, wherein the photo sensor is used to receive infrared signals for proximity detection.

11. The microphone of claim 1, wherein an output of the photo sensor is used to change a setting of an electronic device.

12. A microphone, comprising:
a base;
a cover;
a micro electro mechanical system (MEMS) device disposed on the cover, the MEMS device configured to convert sound into a first electrical signal;
an integrated circuit disposed on the lid and coupled to the MEMS device;
a photo diode disposed on the cover, the photo diode configured to convert light into a second electrical signal;
wherein at least one of the first electrical signal and the second electrical signal is processed by the integrated circuit.

13. The microphone of claim 12, wherein the photo diode couples to the integrated circuit.

14. The microphone of claim 12, wherein the photo diode couples to a device to the exterior of the microphone, and not to the integrated circuit.

15. The microphone of claim 12, wherein the integrated circuit is encapsulated by an encapsulator.

16. The microphone of claim 12, wherein the photodiode is physically separate from the integrated circuit.

17. The microphone of claim 12, wherein the photodiode is physically separate from the integrated circuit.

18. The microphone of claim 12, wherein sound energy and light enter through the same port through the cover.

19. The microphone of claim 12, wherein sound energy and light enter through different pathways through the cover.

20. The microphone of claim 12, wherein the cover comprises a flat lid and walls, and wherein the walls include an electrical conduit that couples to the integrated circuit, wherein the base includes conductive pads that couple to the electrical conduit.

21. The microphone of claim 12, wherein the microphone is disposed in a smartphone, personal computer, or tablet.

22. The microphone of claim 12, wherein the photo sensor is used to receive infrared signals for proximity detection.

23. The microphone of claim 12, wherein an output of the photo sensor is used to change a setting of an electronic device.
